(19) United States
(12) Patent Application Publication
(10) Pub. No.: US 2015/0314545 A1
(43) Pub. Date: Nov. 5, 2015

(54) Aircraft Foam Insulation Method and Apparatus

(71) Applicant: The Boeing Company, Chicago, IL (US)

(72) Inventor: Mark Lawrence Younie, Snohomish, WA (US)

(73) Assignee: The Boeing Company, Chicago, IL (US)

(21) Appl. No.: 14/270,048

(22) Filed: May 5, 2014

(51) Int. Cl. B29D 99/00; B29C 67/00

(52) U.S. Cl. CPC B29D 99/001; B29C 67/0011

(57) ABSTRACT

Methods and apparatus for manufacturing a foam insulation panel to include a panel feature conforming to a first feature of an aircraft sidewall assembly include compressing opposed first and second surfaces of a foam block, advancing a cutter transversely through the foam block to separate the foam block into an excess layer and the foam insulation panel, and translating the foam block by an offset distance determined from the aircraft sidewall assembly first feature to form the panel feature.

### FIELD

The present disclosure generally relates to insulation and, more specifically, to foam insulation used in aircraft.

### BACKGROUND

Fabrication of a commercial aircraft typically consists of building an airframe (sometimes referred to as a primary structure or fuselage) consisting of a series of vertically oriented frames, or ribs, that encircle a cabin area for transporting personnel and cargo. The outboard sides of the frames are covered with an outboard wall or skin and the inboard sides of the frames in the cabin area may similarly be covered with sidewall trim panels. Along the outboard wall and between the frames, other aircraft components such as insulation, electrical conduits, ventilation ducting, control mechanisms, and the like may be installed, so that they may be enclosed between the outboard wall and the sidewall trim panels. Provisions must also be made for windows that must extend through the space between the inner and outboard walls.

The sidewall trim panels of commercial passenger aircraft are typically configured as a number of generally curved vertical panels that extend between the floor and storage bin of the aircraft in a side-to-side manner along either interior wall of the aircraft. Insulation is located behind the sidewall trim panels. The insulation provides a number of functions including regulation of temperature, reduction of engine noise, reduction of noise from outside air turbulence, and protection of mechanical and structural components within the aerospace systems from moisture and temperature extremes that might tend to damage or corrode the components. All of these functions are enhanced by the close contact of insulation to fuselage surfaces including frames, stringers and skin, as well as close contacting fit to brackets or other hardware that is fastened to the frames.

The installation and placement of insulation within the inter-sidewall space can be difficult and time-consuming. Historically, bats of woven insulation or bags of limp fiberglass have been affixed to the exterior wall and fuselage of the aircraft cabin and held in place with brackets and clips inserted through the insulation material, so that they may be held in place until the sidewall trim panels can be installed over the insulation materials. Installation of this type of insulation, however, can be time-consuming and require support brackets that add weight to the aircraft. More recently, self-supporting foam insulation has been introduced that may be fabricated as insulation panels sized for insertion between frame members defining one or more frame bays. The configuration of the insulation panel and how it engages the fuselage frames retains the insulation panel in place without requiring additional brackets or other ancillary support members that add weight to the aircraft.

While the foam insulation panels provide distinct advantages over the previous insulation methods, they can be difficult to fabricate due to the complex contours into which their surfaces must be shaped. In particular, the inboard surface of the insulation panel must generally match the contours of the sidewall trim panel, which may include recessed portions and window reveals. Contouring of the insulation panels is currently accomplished by hand using manual tools. This process requires not only requires skilled craftsmen to properly shape the insulation panel, but also generates dust as foam material is removed that must be controlled to limit release to the immediate environment.

Thus, it is highly desirable to provide an insulation panel and design that is easier to fabricate and reduces generation of dust.

### SUMMARY

In accordance with one aspect of the present disclosure, a method is provided for manufacturing a foam insulation panel to include a first panel feature conforming to a first feature of an aircraft sidewall assembly. The method includes compressing opposed first and second surfaces of a foam insulation block in a first direction, advancing a cutter transversely through the foam insulation block in a second direction substantially perpendicular to the first direction to separate the foam insulation block into an excess layer and the foam insulation panel, and translating the foam insulation block in the first direction by an offset distance determined from the aircraft sidewall assembly first feature to form the first panel feature in the foam insulation panel.

In accordance with another aspect of the present disclosure, a method is provided for manufacturing a foam insulation panel to include a first panel feature conforming to a first feature of an aircraft sidewall assembly. The method includes compressing opposed first and second surfaces of a foam insulation block in a first direction between first and second die rollers, translating the foam insulation block in the first direction by an offset distance determined from the aircraft sidewall assembly first feature with a first male die portion provided on the first roller die and a first female die portion provided on the second roller die, and transversely cutting the foam insulation block in a second direction substantially perpendicular to the first direction as the foam insulation block emerges from the first and second die rollers to separate the foam insulation block into an excess layer and the foam insulation panel, wherein the first male die portion and the first female die portion are configured to form the first panel feature in the foam insulation panel.

In accordance with a further aspect of the present disclosure, surface forming apparatus is provided for manufacturing a foam insulation panel to include a first panel feature conforming to a first feature of an aircraft sidewall assembly. The surface forming apparatus includes first and second roller dies positioned to engage and compress opposed first and second surfaces of a foam block in a first direction, the first and second roller dies being rotatable to advance the foam block along a travel path. A first male die portion is provided on the first roller die and a first female die portion is provided on the second roller die and shaped complementary to the first male die portion, the first male and female die portions being configured to translate the foam insulation block in the first direction by an offset distance. A cutter is positioned along the travel path downstream of the first and second roller dies and oriented to transversely cut the foam insulation block in a second direction substantially perpendicular to the first direction thereby to separate the foam insulation block into an excess layer and the foam insulation panel, wherein the first male die portion and the first female die portion are configured to form the first panel feature in the foam insulation panel.

In another aspect of the disclosure that may be combined with any of these aspects, compressing and translating the foam insulation block are performed simultaneously.

In another aspect of the disclosure that may be combined with any of these aspects, first and second roller dies are configured to compress and translate the foam insulation block.

In another aspect of the disclosure that may be combined with any of these aspects, the first roller die includes a first male die portion and the second roller die includes a first female die portion having a shape complementary to the first male die portion, wherein the first male die portion and the first female die portion are sized relative to the aircraft sidewall assembly first feature.

In another aspect of the disclosure that may be combined with any of these aspects, the aircraft sidewall assembly further comprises a second feature, the method further comprising translating the foam insulation block in the first direction by a second offset distance determined from the aircraft sidewall assembly second feature.

In another aspect of the disclosure that may be combined with any of these aspects, the first roller die includes a second male die portion, the second roller die includes a second female die portion having a shape complementary to the second male die portion, and the second male die portion and the second female die portion are sized relative to the aircraft sidewall assembly second feature.

In another aspect of the disclosure that may be combined with any of these aspects, the first and second male die portions are positioned in a tiered configuration on the first roller die, and in which the first and second female die portions are positioned in a tiered configuration on the second roller die.

In another aspect of the disclosure that may be combined with any of these aspects, the aircraft sidewall assembly first feature comprises a window reveal defining a trim opening and the aircraft sidewall assembly second feature comprises a trim recess, and in which the first male and female die portions are configured to form the first panel feature as a window aperture corresponding to the trim opening, and the second male and female die portions are configured to form the second panel feature as a curved recess contour having a shape complementary to the trim recess.

In another aspect of the disclosure that may be combined with any of these aspects, the aircraft sidewall assembly first feature comprises a window reveal defining a trim opening, and in which the first male die portion and the first female die portion are configured to form the first panel feature as a window aperture corresponding to the trim opening.

In another aspect of the disclosure that may be combined with any of these aspects, the offset distance of the first male and female die portions is determined from the aircraft sidewall assembly first feature.

In another aspect of the disclosure that may be combined with any of these aspects, the aircraft sidewall assembly further includes a second feature, and in which the apparatus further includes a second male die portion provided on the first roller die, and a second female die portion provided on the second roller die and shaped complementary to the second male die portion, the second male and female die portions configured to translate the foam insulation block in the first direction by a second offset distance.

In another aspect of the disclosure that may be combined with any of these aspects, the second offset distance of the second male and female die portions is determined from the aircraft sidewall assembly second feature.

The features, functions, and advantages that have been discussed can be achieved independently in various embodiments or may be combined in yet other embodiments further details of which can be seen with reference to the following description and drawings:

### BRIEF DESCRIPTION OF THE DRAWINGS

FIG. 1 shows an exploded, perspective view of a trim sidewall, foam insulation panel, and airframe according to an embodiment of the present disclosure.

FIG. 2 shows a side elevation view of surface forming apparatus with first and second roller dies in a first rotational position, according to an embodiment of the present disclosure.

FIG. 3 shows a side elevation view of the surface forming apparatus of FIG. 2 with the first and second roller dies in a second rotational position.

FIG. 4 shows enlarged perspective views of the first and second roller dies used in the surface forming apparatus of FIGS. 2 and 3.

FIG. 5 is a flow diagram of a method for manufacturing a foam insulation panel to include a panel feature conforming to a first feature of an aircraft sidewall assembly, according to an embodiment of the present disclosure.

It should be understood that the drawings are not necessarily drawn to scale and that the disclosed embodiments are sometimes illustrated schematically. It is to be further appreciated that the following detailed description is merely exemplary in nature and is not intended to limit the invention or the application and uses thereof. Hence, although the present disclosure is, for convenience of explanation, depicted and described as certain illustrative embodiments, it will be appreciated that it can be implemented in various other types of embodiments and in various other systems and environments.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

For ease of understanding the orientation in the drawings, the terms “inside”, “inboard”, and “interior” shall refer a direction oriented from the viewpoint of a person standing within the cabin of the aircraft, and the terms “outside”, “outboard”, and “exterior” shall refer to a direction oriented from the viewpoint of a person outside of the cabin observing the aircraft. Thus, a foam insulation panel will have an interior side and an exterior side, where the interior side is the insulation panel surface facing a trim sidewall of the aircraft and the exterior side is the insulation panel surface facing an outboard wall of the aircraft. Other such descriptions will be obvious from the context.

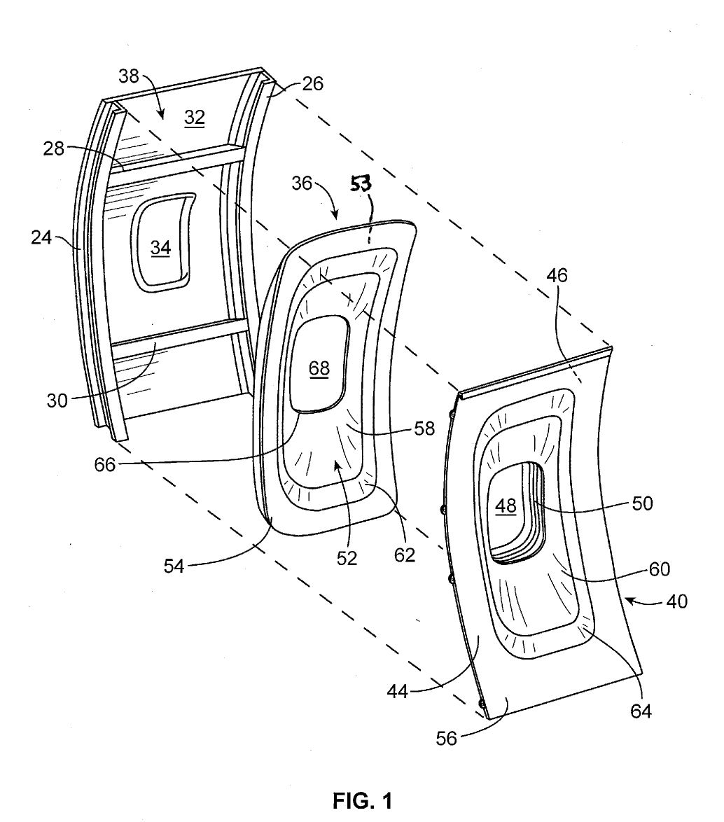

FIG. 1 illustrates a section of an aircraft frame bay 38 including vertical frame members 24, 26 and horizontal stringers 28, 30. An outboard wall 32 may be coupled to exterior sides of the frame members 24, 26 and stringers 28, 30 and may include an opening 34. A foam insulation panel 36 may be configured for insertion into the frame bay 38 between the vertical frame members 24, 26, and a trim sidewall 40 may be attached to the frame bay 38 to extend over the foam insulation panel 36. The trim sidewall 40 may be formed as a curved structure that is pre-shaped to conform to the curve of the aircraft frame bay 38, so that an inboard surface 44 of the trim sidewall 40 may have a generally concave aspect and an outboard surface 46 of the trim sidewall may have a generally convex aspect. The trim sidewall 40 may define a trim opening 48 to accommodate a window reveal 50. The trim opening 48 may be configured to oppose the opening 34 formed in the outboard wall 32.

The foam insulation panel 36 may have a panel inboard surface 52 sized and shaped to closely fit against the trim sidewall 40. More specifically, the panel inboard surface 52 may include one or more panel features, such as contours, shapes, apertures, or voids that conform to or otherwise accommodate features provided in the trim sidewall 40. For example, a panel perimeter frame contour 54 may extend around an outer edge of the foam insulation panel that is shaped to conform to an outer periphery 56 of the trim sidewall 40. The foam insulation panel 36 may also include a curved recess contour 58 extending in an outboard direction relative to the panel perimeter frame 54 that is shaped complementary to a trim recess 60 of the trim sidewall 40. A transition contour 62 may be formed in the foam insulation panel 36 that extends between the panel perimeter frame contour 54 and the curved recess contour 58 and conforms to a window transition 64 of the trim sidewall 40. Still further, the foam insulation panel 36 may include a window contour 66 formed in the curved recess contour 58 and defining a window aperture 68, with the window contour 66 conforming to the shape of the window reveal 50 of the trim sidewall 40.

Additionally or alternatively, the foam insulation panel 36 may have a panel outboard surface 53 sized and shaped to closely fit against the frame bay 38. The panel outboard surface 53 may include one or more panel features, such as contours, shapes, apertures, or voids that conform to or otherwise accommodate features provided in the frame bay 38. For example, the frame bay 38 may include openings, brackets, shade mechanisms, or other structures, and the panel outboard surface 53 may be formed with panel features that are shaped complementary to or otherwise conform to the features provided in the frame bay 38.

As used herein, the term “aircraft sidewall assembly” includes the frame bay 38 and the trim sidewall 40. Accordingly, a feature of the aircraft sidewall assembly may be provided by or associated with the frame bay 38, the trim sidewall 40, or both. Similarly, the panel feature may be provided on the panel inboard surface 52, the panel outboard surface 53, or both panel surfaces. Still further, the foam insulation panel 36 may include multiple panel features formed on the inboard surface 52, outboard surface 53, or both surfaces. In some embodiments, the panel feature may extend entirely through a thickness of the foam insulation panel 36 to form on aperture or other void.

The foam insulation panel 36 may be formed of material selected for one or more advantageous properties. Exemplary advantageous properties include high sound absorption, high heat resistance, sufficient fireproof qualities, sufficient flexibility, and/or is easy to process into desired shapes. Suitable foam insulation materials include polymeric, cellular, or solid member materials having a density of less than 0.4 pounds per cubic foot. Preferred foam compositions include the melamine-based open-celled thermosetting foams, polyimide foams, or other foam compositions.

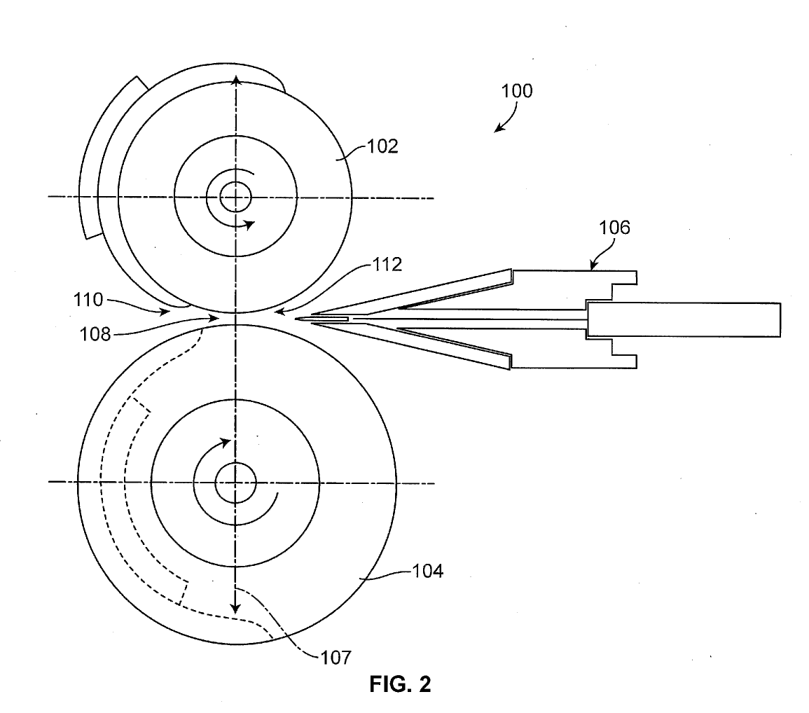

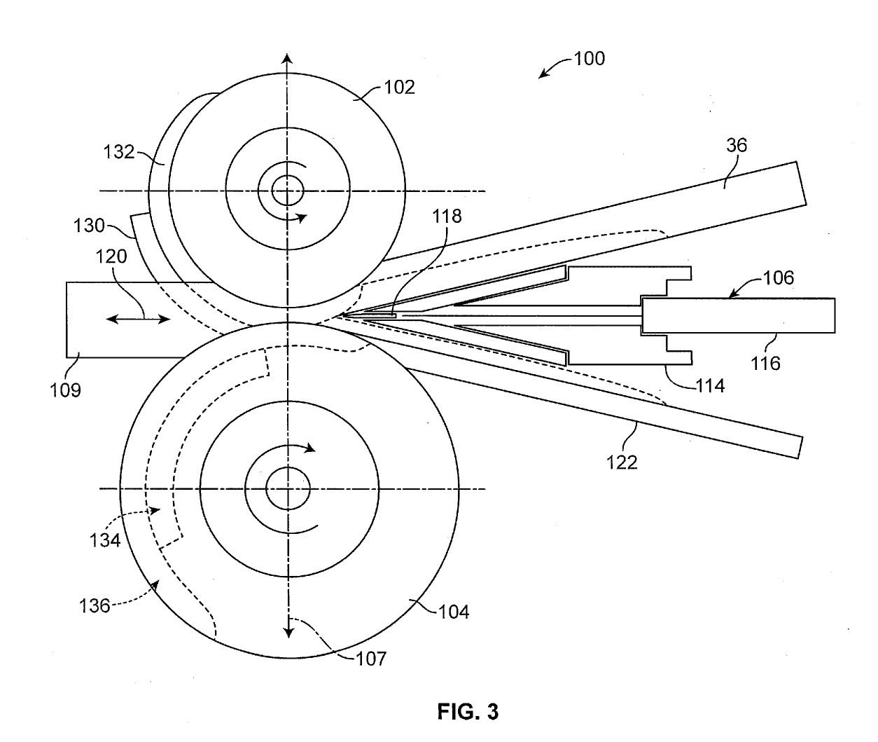

Referring now to FIGS. 2-4, surface forming apparatus 100 may be employed to automate the formation of one or more panel features in the foam insulation panel 36, thereby minimizing or eliminating the drawbacks associated with manual shaping of the panels. In the exemplary embodiment, the surface forming apparatus 100 may include a first roller die 102, a second roller die 104, and a cutter assembly 106. The first and second roller dies 102, 104 may be spaced apart by a distance that defines a nip 108 (FIG. 2) therebetween that is sized to engage and compress opposed surfaces of a foam block 109 (FIG. 3) in a first direction 107. In operation, the first and second roller dies 102, 104 are counter-rotated so that a foam block 109 fed into the upstream side 110 of the nip 108 is engaged, compressed, and advanced along a travel path toward a downstream side 112 of the nip 108.

The cutter assembly 106 is positioned along the travel path downstream of the nip 108. As best shown in FIGS. 2 and 3, the cutter assembly 106 may include a support head 114 coupled to a cutting head actuator 116. A cutting blade 118 may be coupled to the support head 114 and configured to cut through the foam insulation material. In operation, as the foam block 109 is advanced downstream along the travel path, the cutting blade 118 is oriented to transversely cut the foam insulation block 109 in a second direction 120 substantially perpendicular to the first direction 107, thereby to separate the foam insulation block 109 into an excess layer 122 and the foam insulation panel 36. The cutting blade 118 may be positioned so that it engages the foam block 109 while the foam block is still at least partially compressed by the roller dies 102, 104.

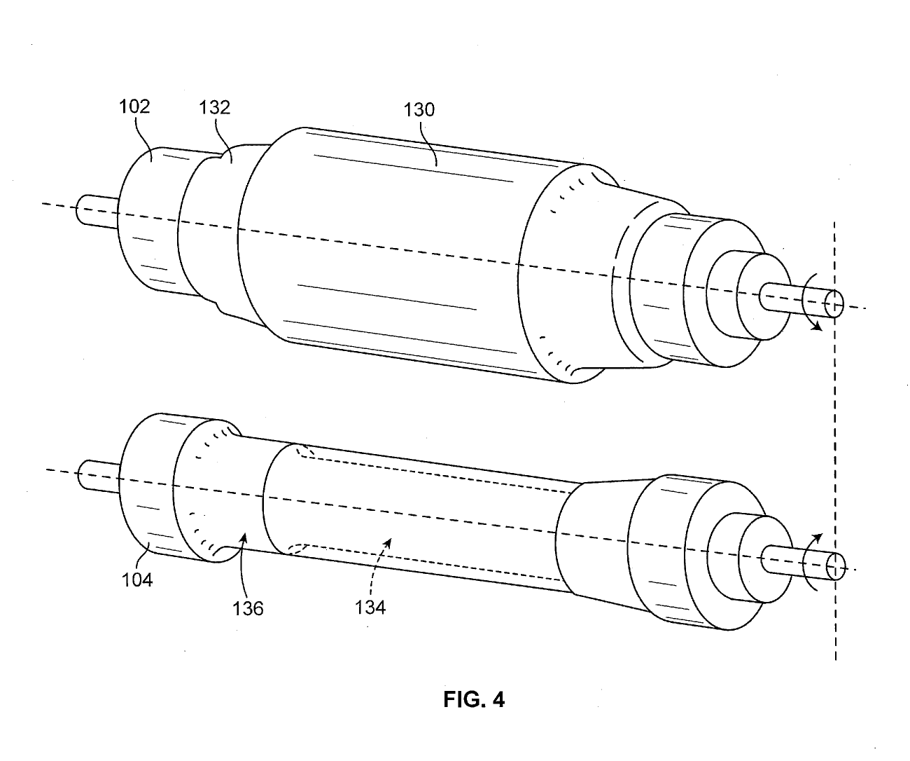

The first and second roller dies 102, 104 may be configured to manipulate the position of the foam block 109 relative to the cutting blade 118, thereby to form one or more panel features in the foam insulation panel 36 that conform to features of the aircraft sidewall assembly. For example, as best shown in FIG. 4, the first roller die 102 may include a first male die portion 130 and a second male die portion 132. Similarly, the second roller die 104 may include a first female die portion 134 and a second female die portion 136. The first male die portion 130 may be shaped complementary to the first female die portion 134, while the second male die portion 132 may be shaped complementary to the second female die portion 136. The associated sets of male/female die portions effectively translate the foam block 109 along the first direction 107 relative to the cutting blade 118, thereby to form panel features in the foam insulation panel 36. For example, the associated pair of first male and female die portions 130, 134 may translate the foam block 109 by a first offset distance, while the associated pair of second male and female die portions 132, 136 may translate the foam block 109 by a second offset distance that is less than the first offset distance. The first and second offset distances may be pre-determined from the aircraft sidewall assembly features to which the panel features may conform.

In the illustrated embodiment, the first and second male die portions 130, 134 are arranged on the first roller die 102 in a tiered configuration. Similarly, the first and second female die portions 134, 136 are also arranged in a tiered configuration on the second roller die 104. Alternative configurations may be used without departing from the scope of the claims.

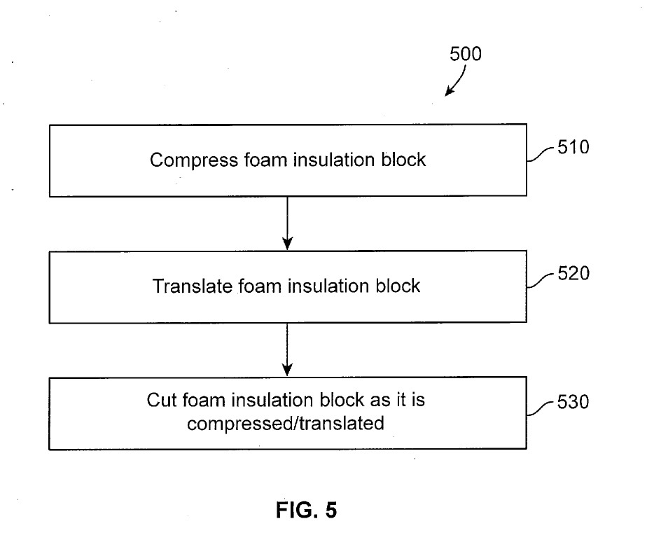

In view of the foregoing, an automated method 500 for manufacturing the foam insulation panel 36 to include one or more panel features conforming to one or more associated feature of the aircraft sidewall assembly may be performed, as illustrated by the flow diagram of FIG. 5. The steps of the method may be performed in other sequences than the particular sequence shown, and the particular sequence shown by the flowchart is representative.

At block 510, opposed first and second surfaces of a foam insulation block 109 may be compressed in a first direction 107, such as between first and second die rollers 102, 104. At block 520, the foam insulation block 109 may be translated in the first direction 107 by an offset distance determined from the aircraft sidewall assembly first feature. Translation in the first direction 107 may be performed by the first male die portion 130 provided on the first roller die 102 and a first female die portion 134 provided on the second roller die 104. The compression and translation operations identified by blocks 510 and 520 may occur in the sequence shown, in an opposite sequence (where translation occurs prior to compression), or simultaneously (as may occur with the die rollers 102, 104 illustrated in FIGS. 2-4).

At block 530, the foam insulation block 109 may be transversely cut in a second direction 120 substantially perpendicular to the first direction 107 as the foam insulation block 109 emerges from the first and second die rollers 102, 104, thereby to separate the foam insulation block into the excess layer 122 and the foam insulation panel 36. The compression and/or translation of the foam insulation block 109 adjusts the position of the foam block 109 relative to the cutter, so that the panel features may be formed.

Apparatus and methods are disclosed for automating the formation of panel features in a foam insulation panel. The apparatus and methods are more precise and easily repeatable when compared to the conventional manual processes used to shape and form the foam insulation panels, thereby reducing the time needed to manufacture panel features that sufficiently conform to features provided in the aircraft sidewall assembly (i.e., the frame bay 38 and/or the trim sidewall 40.

What is claimed is:

1. A method for manufacturing a foam insulation panel to include a first panel feature conforming to a first feature of an aircraft sidewall assembly, the method comprising:
compressing opposed first and second surfaces of a foam insulation block in a first direction;
advancing a cutter transversely through the foam insulation block in a second direction substantially perpendicular to the first direction to separate the foam insulation block into an excess layer and the foam insulation panel; and
translating the foam insulation block in the first direction by an offset distance determined from the aircraft sidewall assembly first feature to form the first panel feature in the foam insulation panel.

2. The method of claim 1, in which compressing and translating the foam insulation block are performed simultaneously.

3. The method of claim 2, in which first and second roller dies are configured to compress and translate the foam insulation block.

4. The method of claim 3, in which the first roller die includes a first male die portion and the second roller die includes a first female die portion having a shape complementary to the first male die portion, wherein the first male die portion and the first female die portion are sized relative to the aircraft sidewall assembly first feature.

5. The method of claim 4 in which the aircraft sidewall assembly further comprises a second feature, the method further comprising translating the foam insulation block in the first direction by a second offset distance determined from the aircraft sidewall assembly second feature to form a second panel feature in the foam insulation panel.

6. The method of claim 5, in which the first roller die includes a second male die portion, the second roller die includes a second female die portion having a shape complementary to the second male die portion, and the second male die portion and the second female die portion are sized relative to the aircraft sidewall assembly second feature.

7. The method of claim 6, in which the first and second male die portions are positioned in a tiered configuration on the first roller die, and in which the first and second female die portions are positioned in a tiered configuration on the second roller die.

8. The method of claim 6, in which the aircraft sidewall assembly first feature comprises a window reveal defining a trim opening and the aircraft sidewall assembly second feature comprises a trim recess, and in which the first male and female die portions are configured to form the first panel feature as a window aperture corresponding to the trim opening, and the second male and female die portions are configured to form the second panel feature as a curved recess contour having a shape complementary to the trim recess.

9. A method for manufacturing a foam insulation panel to include a first panel feature conforming to a first feature of an aircraft sidewall assembly, the method comprising:
compressing opposed first and second surfaces of a foam insulation block in a first direction between first and second die rollers;
translating the foam insulation block in the first direction by an offset distance determined from the aircraft sidewall assembly first feature with a first male die portion provided on the first roller die and a first female die portion provided on the second roller die; and
transversely cutting the foam insulation block in a second direction substantially perpendicular to the first direction as the foam insulation block emerges from the first and second die rollers to separate the foam insulation block into an excess layer and the foam insulation panel, wherein the first male die portion and the first female die portion are configured to form the first panel feature in the foam insulation panel.

10. The method of claim 9, in which the aircraft sidewall assembly first feature comprises a window reveal defining a trim opening, and in which the first male die portion and the first female die portion are configured to form the first panel feature as a window aperture corresponding to the trim opening.

11. The method of claim 9, in which the aircraft sidewall assembly comprises a second feature, the method further comprising translating the foam insulation block in the first direction by a second offset distance determined from the aircraft sidewall assembly second feature with a second male die portion provided on the first roller die and a second female die portion provided on the second roller die.

12. The method of claim 11, in which the aircraft sidewall assembly first feature comprises a window reveal defining a trim opening and the aircraft sidewall assembly second feature comprises a trim recess, and in which the first male and female die portions are configured to form the first panel feature as a window aperture corresponding to the trim opening, and the second male and female die portions are configured to form the second panel feature as a curved recess contour having a shape complementary to the trim recess.

13. The method of claim 9, in which the first and second male die portions are positioned in a tiered configuration on the first roller die, and in which the first and second female die portions are positioned in a tiered configuration on the second roller die.

14. Surface forming apparatus for manufacturing a foam insulation panel to include a first panel feature conforming to a first feature of an aircraft sidewall assembly, the surface forming apparatus comprising:
first and second roller dies positioned to engage and compress opposed first and second surfaces of a foam block in a first direction, the first and second roller dies being rotatable to advance the foam block along a travel path;
a first male die portion provided on the first roller die and a first female die portion provided on the second roller die and shaped complementary to the first male die portion, the first male and female die portions configured to translate the foam insulation block in the first direction by an offset distance;
a cutter positioned along the travel path downstream of the first and second roller dies and oriented to transversely cut the foam insulation block in a second direction substantially perpendicular to the first direction thereby to separate the foam insulation block into an excess layer and the foam insulation panel, wherein the first male die portion and the first female die portion are configured to form the first panel feature in the foam insulation panel.

15. The apparatus of claim 14, in which the offset distance of the first male and female die portions is determined from the aircraft sidewall assembly first feature.

16. The apparatus of claim 14, in which the aircraft sidewall assembly further includes a second feature, and in which the apparatus further includes a second male die portion provided on the first roller die, and a second female die portion provided on the second roller die and shaped complementary to the second male die portion, the second male and female die portions configured to translate the foam insulation block in the first direction by a second offset distance.

17. The apparatus of claim 16, in which the second offset distance of the second male and female die portions is determined from the aircraft sidewall assembly second feature.

18. The apparatus of claim 16, in which the first and second male die portions are positioned in a tiered configuration on the first roller die, and in which the first and second female die portions are positioned in a tiered configuration on the second roller die.

19. The apparatus of claim 16, in which the aircraft sidewall assembly first feature comprises a window reveal defining a trim opening and the aircraft sidewall assembly second feature comprises a trim recess, and in which the first male and female die portions are configured to form the first panel feature as a window aperture corresponding to the trim opening, and the second male and female die portions are configured to form the second panel feature as a curved recess contour having a shape complementary to the trim recess.

20. The apparatus of claim 14, in which the aircraft sidewall assembly first feature comprises a window reveal defining a trim opening, and in which the first male and female die portions are configured to form the first panel feature as a window aperture corresponding to the trim opening.
